(19) United States
(12) Patent Application Publication
(10) Pub. No.: US 2017/0353803 A1
(43) Pub. Date: Dec. 7, 2017

(54) MICROPHONE

(71) Applicant: Huawei Technologies Co., Ltd., Shenzhen, Guangdong (CN)

(72) Inventors: Jun Ding, Shenzhen (CN); Fang-Ching Lee, Shanghai (CN)

(21) Appl. No.: 15/539,625

(22) PCT Filed: Dec. 25, 2014
(86) PCT No.: PCT/CN14/94978

§ 371 Date: Jun. 23, 2017

(51) Int. Cl. H04R 19/04; H04R 1/04

(52) U.S. Cl. CPC H04R 19/04; H04R 1/04

(57) ABSTRACT

Embodiments of the present invention provide a microphone, including: a metal cover and a printed circuit board PCB that is connected to the metal cover and that is provided with a sound pickup hole, and further including a boss that is provided with a through hole, where the boss is disposed on a side, away from the metal cover, of the PCB, and the boss is located on a soldering pad surrounding the sound pickup hole, so as to prevent soldering tin and a solder flux from entering the sound pickup hole, and the through hole is in communication with the sound pickup hole, so that an audio signal enters the sound pickup hole through the through hole.

### CROSS-REFERENCE TO RELATED APPLICATION

This application is a National Stage of International Application No. PCT/CN2014/094978, filed on Dec. 25, 2014, which is hereby incorporated by reference in its entirety.

### TECHNICAL FIELD

Embodiments of the present invention relate to communications technologies, and in particular, to a microphone.

### BACKGROUND

FIG. 1 is a schematic structural diagram of a bottom pickup microphone in the prior art. FIG. 2 is a schematic sectional diagram of a bottom pickup microphone in the prior art. The microphone is a built-in microphone used for a terminal device, for example, a built-in microphone of a terminal device such as a mobile phone or a tablet computer. As shown in FIG. 1 and FIG. 2, the bottom pickup microphone includes a metal cover 1 and a printed circuit board (printed circuit board, PCB for short) 2 of the microphone. A plurality of soldering pads 3 and a sound pickup hole 5 are provided on the PCB 2 of the microphone, and a liquid photoimagable solder mask 4 is provided on a periphery of the sound pickup hole 5.

FIG. 3 is a schematic structural diagram of a microphone and a terminal device being soldered in the prior art. As shown in FIG. 3, a PCB 2 of the microphone and a PCB 6 of the terminal device are soldered together by using a soldering pad, a position of a sound pickup hole 4 of the microphone corresponds to a position of a sound pickup hole 7 of the terminal device, the sound pickup hole 4 is in communication with the sound pickup hole 7, and a liquid photoimagable solder mask 4 is used for preventing soldering tin from entering the sound pickup hole of the microphone (Microphone, Mic for short) in a soldering process.

However, during soldering for a bottom pickup microphone by using an oven, because flow directions of soldering tin and a solder flux cannot be precisely controlled, a liquid photoimagable solder mask still cannot entirely prevent the soldering tin and the solder flux from entering a sound pickup hole of the microphone, thereby causing problems of silence or noise that exist in a Mic of a terminal device.

### SUMMARY

Embodiments of the present invention provide a microphone to effectively prevent soldering tin and a solder flux from entering a sound pickup hole, so that problems of silence or noise that exist in the microphone are avoided.

A first aspect of the embodiments of the present invention provides a microphone, including:

a metal cover, and a printed circuit board PCB of the microphone that is connected to the metal cover and that is provided with a sound pickup hole, and further including a boss that is provided with a through hole, where

the boss is disposed on a side, away from the metal cover, of the PCB, and the boss is located on a soldering pad surrounding the sound pickup hole, so as to prevent soldering tin and a solder flux from entering the sound pickup hole; and

the through hole is in communication with the sound pickup hole, so that an audio signal enters the sound pickup hole through the through hole.

In a first possible implementation manner of the first aspect, a diameter of the through hole is greater than or equal to a diameter of the sound pickup hole.

With reference to the first possible implementation manner of the first aspect, in a second possible implementation manner of the first aspect, a height of the boss is greater than 0 mm and is less than or equal to 20 mm.

With reference to the second possible implementation manner of the first aspect, in a third possible implementation manner of the first aspect, the boss is interference-fitted into the sound pickup hole, so that the boss is riveted on the PCB.

With reference to the second possible implementation manner of the first aspect, in a fourth possible implementation manner of the first aspect, the boss is a boss that is formed after a holeless boss is bonded to the PCB by using a heat-resistant glue and is disposed above the sound pickup hole and a hole is punched in the holeless boss.

With reference to the second possible implementation manner of the first aspect, in a fifth possible implementation manner of the first aspect, the boss is a boss that is obtained by milling above the sound pickup hole of the PCB by using a numerical control machine tool.

With reference to the second possible implementation manner of the first aspect, in a sixth possible implementation manner of the first aspect, a material of the boss is a metal, a heat-resistant plastic, or a ceramic.

With reference to the second possible implementation manner of the first aspect, in a seventh possible implementation manner of the first aspect, a diameter of the boss is less than a diameter of the soldering pad surrounding the sound pickup hole.

According to the microphone provided in the embodiments, an annular boss is disposed on a PCB and surrounding a sound pickup hole. Therefore, when the microphone is soldered to a PCB of a terminal through an oven, soldering tin and a solder flux are blocked by the boss after the soldering tin and the solder flux flow around the boss, thereby effectively preventing the soldering tin and the solder flux from entering the sound pickup hole, so that problems of silence or noise that exist in the microphone are avoided.

### BRIEF DESCRIPTION OF THE DRAWINGS

To describe the technical solutions in the embodiments of the present invention or in the prior art more clearly, the following briefly describes the accompanying drawings required for describing the embodiments or the prior art. Apparently, the accompanying drawings in the following description show some embodiments of the present invention, and persons of ordinary skill in the art may still derive other drawings from these accompanying drawings without creative efforts.

FIG. 1 is a schematic structural diagram of a bottom pickup microphone in the prior art;

FIG. 2 is a schematic sectional diagram of a bottom pickup microphone in the prior art;

FIG. 3 is a schematic structural diagram of a microphone and a terminal device being soldered in the prior art;

FIG. 4 is a schematic structural diagram of a microphone according to Embodiment 1 of the present invention;

FIG. 5 is a schematic sectional diagram of a microphone according to Embodiment 1 of the present invention;

FIG. 6 is a schematic structural diagram of a microphone and a terminal device being soldered according to an embodiment of the present invention;

FIG. 7 is a schematic sectional diagram of a microphone according to Embodiment 2 of the present invention;

FIG. 8 is a schematic structural diagram of a manufacturing process of a boss of a microphone according to Embodiment 3 of the present invention; and

FIG. 9 is a schematic structural diagram of a manufacturing process of a boss of a microphone according to Embodiment 4 of the present invention.

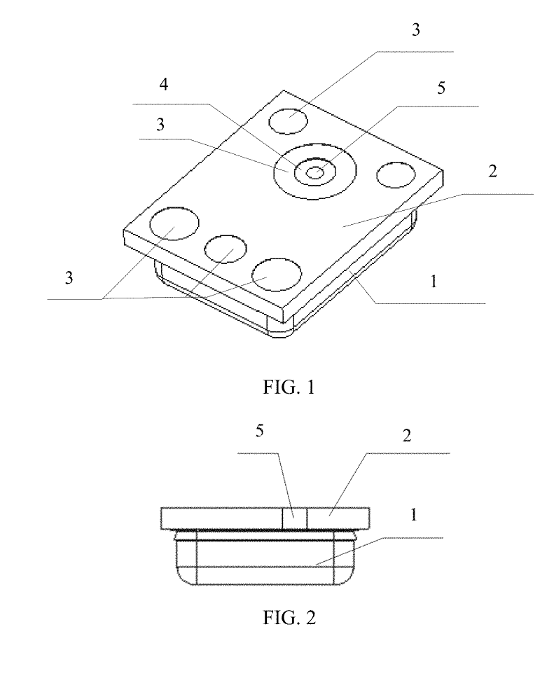

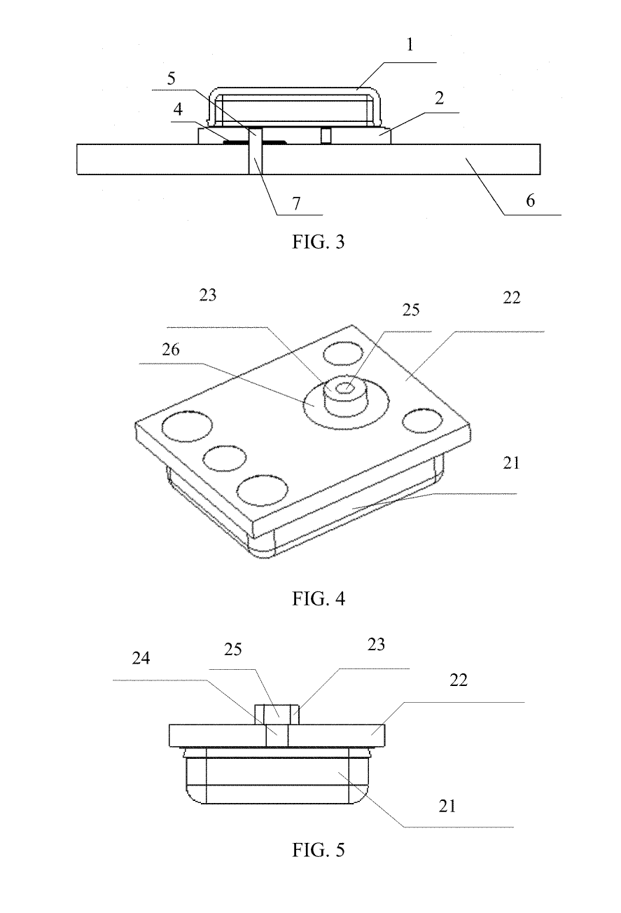

### DETAILED DESCRIPTION

To make the objectives, technical solutions, and advantages of the embodiments of the present invention clearer, the following clearly describes the technical solutions in the embodiments of the present invention with reference to the accompanying drawings in the embodiments of the present invention. Apparently, the described embodiments are some but not all of the embodiments of the present invention. All other embodiments obtained by persons of ordinary skill in the art based on the embodiments of the present invention without creative efforts shall fall within the protection scope of the present invention.

FIG. 4 is a schematic structural diagram of a microphone according to Embodiment 1 of the present invention. FIG. 5 is a schematic sectional diagram of a microphone according to Embodiment 1 of the present invention. As shown in FIG. 4 and FIG. 5, the microphone includes a metal cover 21, a PCB 22 of the microphone that is connected to the metal cover 21 and that is provided with a sound pickup hole 24, and a boss 23 that is provided with a through hole 25. A soldering pad 26 is disposed on a periphery of the sound pickup hole, so that the PCB 22 of the microphone is soldered to a PCB of a terminal device. The boss 23 is disposed on a side, away from the metal cover 21, of the PCB 22, and the boss 23 is located on the soldering pad 26 surrounding the sound pickup hole 24, so as to prevent soldering tin and a solder flux from entering the sound pickup hole. In addition, the through hole 25 is in communication with the sound pickup hole 24, so that an audio signal enters the sound pickup hole 24 through the through hole 25.

In this embodiment, a diameter of the through hole being greater than, equal to or less than a diameter of the sound pickup hole can always implement communication between the through hole 25 and the sound pickup hole 24. When the diameter of the through hole 25 is greater than or equal to the diameter of the sound pickup hole 24, the boss 23 can be disposed above the sound pickup hole 24, and when the diameter of the through hole 25 is less than the diameter of the sound pickup hole 24, the boss 23 can be directly inserted into the sound pickup hole 24. This is not limited in the present invention.

Preferably, in this embodiment, the diameter of the through hole 25 is greater than or equal to the diameter of the sound pickup hole 24.

In this embodiment, because a diameter of a through hole is greater than or equal to a diameter of a sound pickup hole, an audio feature of an audio signal that enters the sound pickup hole through the through hole can be better ensured.

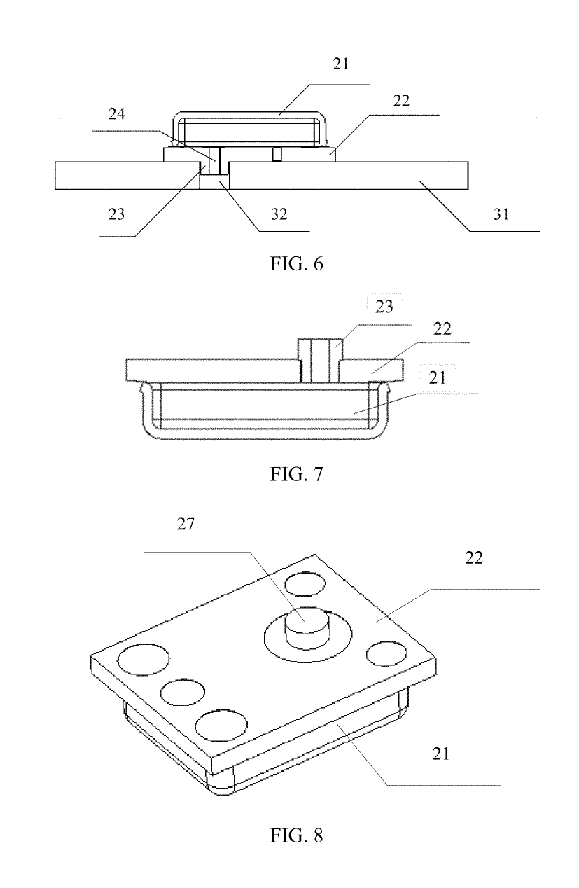

The microphone provided in this embodiment may be set on a terminal device such as a mobile phone, a computer, or a handheld terminal, and the microphone and a PCB of the terminal device are soldered together by using a soldering pad on a PCB of the microphone. FIG. 6 is a schematic structural diagram of a microphone and a terminal device being soldered according to an embodiment of the present invention. As shown in FIG. 6, a PCB 22 of the microphone and a PCB 31 of the terminal device are soldered together, and a boss 23 is inserted into a sound pickup hole 32 of the terminal device. When the boss 23 is soldered through an oven, the boss 23 can effectively prevent soldering tin and a solder flux from entering the sound pickup hole of the microphone.

It should be noted that the boss in this embodiment may be a boss of an annular shape, a square boss that is provided with a through hole in the middle, a hexagonal boss that is provided with a through hole in the middle, or a boss of another shape. The present invention merely uses a boss of an annular shape as an example to describe technical solutions of the embodiments of the present invention. Besides, a size and a shape of the boss 23 can be set and adjusted according to the sound pickup hole 32 of the terminal device. This is not limited in the present invention.

Optionally, in this embodiment, a material of the boss is a metal, a heat-resistant plastic, or a ceramic. Other materials may be selected to manufacture the boss. This is not limited in the present invention.

According to the microphone provided in this embodiment, an annular boss is disposed on a PCB and surrounding a sound pickup hole. Therefore, when the microphone is soldered to a PCB of a terminal through an oven, soldering tin and a solder flux are blocked by the boss after the soldering tin and the solder flux flow around the boss, thereby effectively preventing the soldering tin and the solder flux from entering the sound pickup hole, so that problems of silence or noise that exist in the microphone are avoided.

Preferably, in this embodiment, a height of the boss is greater than 0 mm and less than or equal to 20 mm.

In this embodiment, a person skilled in the art can set the size of the boss according to an actual requirement, so that the boss can be better connected to the sound pickup hole, thereby effectively preventing the soldering tin and the solder flux from entering the sound pickup hole.

Preferably, in this embodiment, a diameter of the boss is less than a diameter of the soldering pad surrounding the sound pickup hole.

In this embodiment, a plurality of soldering pads is disposed on the PCB 22 of the microphone, so that the microphone and the terminal device are soldered together by using the soldering pads, where the diameter of the boss 23 is less than the diameter of the soldering pad 26 surrounding the sound pickup hole 24 of the microphone.

FIG. 7 is a schematic sectional diagram of a microphone according to Embodiment 2 of the present invention. On the basis of the forgoing embodiment shown in FIG. 4, as shown in FIG. 7, the boss 23 is interference-fitted into the sound pickup hole 24, so that the boss 23 is riveted on the PCB 22.

According to the microphone provided in this embodiment, a boss is interference-fitted into a sound pickup hole, so that the boss is riveted on a PCB, which effectively prevents soldering tin and a solder flux from entering the sound pickup hole, thereby avoiding problems of silence or noise that exist in the microphone, so that a bottom pickup microphone component that is forbidden to be selected becomes an optional component, thereby effectively reducing a fault feedback ratio (Fault Feedback Ratio, FFR for short) problem of a bottom pickup microphone project caused by entering of the soldering tin.

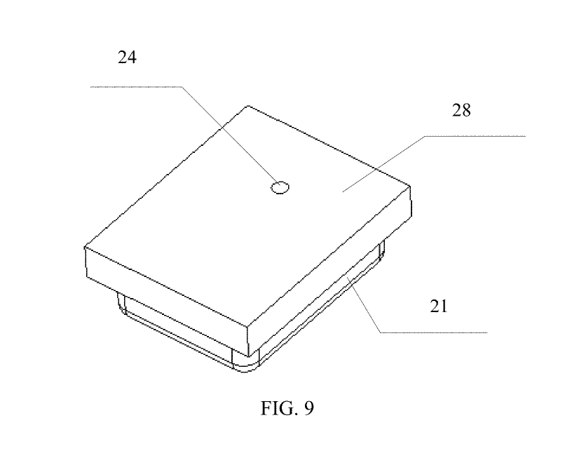

FIG. 8 is a schematic structural diagram of a manufacturing process of a boss of a microphone according to Embodiment 3 of the present invention. As shown in FIG. 6, a holeless boss 27 is bonded to the PCB 22 by using a heat-resistant glue and is disposed above the sound pickup hole, a hole is punched in the holeless boss 27 to form a boss, and a boss that is shaped is shown as the boss 23 in FIG. 4.

According to the microphone provided in this embodiment, a holeless boss is bonded to a PCB by using a heat-resistant glue, and the holeless boss is punched to form a boss. When soldering is performed, soldering tin and a solder flux are blocked by the boss when the soldering tin and the solder flux flow around the boss, which effectively prevents the soldering tin and the solder flux from entering a sound pickup hole, thereby avoiding problems of silence or noise that exist in the microphone, so that a bottom pickup microphone component that is forbidden to be selected becomes an optional component, thereby effectively reducing an FFR problem of a bottom pickup microphone project caused by entering of the soldering tin.

FIG. 9 is a schematic structural diagram of a manufacturing process of a boss of a microphone according to Embodiment 4 of the present invention. As shown in FIG. 9, the boss is a boss that is obtained by milling above a sound pickup hole 24 of a PCB 28 by using a numerical control machine tool, and a boss that is shaped is shown as the boss 23 in FIG. 4.

It should be noted that in this embodiment, a thickness of the PCB is greater than a thickness of the PCB in the forgoing Embodiments 1 to 3, and a specific thickness of the PCB can be set according to an actual requirement. This is not limited in the present invention.

According to the microphone provided in this embodiment, a boss that is obtained by milling above a sound pickup hole of a PCB by using a numerical control machine tool is used, which effectively prevents soldering tin and a solder flux from entering the sound pickup hole, thereby avoiding problems of silence or noise that exist in the microphone, so that a bottom pickup microphone component that is forbidden to be selected becomes an optional component, thereby effectively reducing an FFR problem of a bottom pickup microphone project caused by entering of the soldering tin.

Optionally, in the embodiments of the present invention, a ceramic substrate solution or a micro-electro-mechanical system (Micro-Electro-Mechanical System, MEMS for short) MEMS process solution may be used. For example, it is implemented that a boss is made at a sound pickup hole by using a photolithography of a positive photoresist and a negative photoresist or the like.

Finally, it should be noted that the foregoing embodiments are merely intended for describing the technical solutions of the present invention, but not for limiting the present invention. Although the present invention is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present invention.

1. A microphone, comprising:
a metal cover;
a printed circuit board (PCB) connected to the metal cover and provided with a sound pickup hole, and further comprising a boss with a through hole, wherein the boss is disposed on a side, away from the metal cover, of the PCB, and the boss is located on a soldering pad surrounding the sound pickup hole, so as to prevent soldering tin and a solder flux from entering the sound pickup hole; and
wherein the through hole is in communication with the sound pickup hole, so that an audio signal enters the sound pickup hole through the through hole.

2. The microphone according to claim 1, wherein a diameter of the through hole is greater than or equal to a diameter of the sound pickup hole.

3. The microphone according to claim 1, wherein a height of the boss is less than or equal to 20 mm.

4. The microphone according to claim 1, wherein the boss is interference-fitted into the sound pickup hole, so that the boss is riveted on the PCB.

5. The microphone according to claim 1, wherein the boss is formed after a holeless boss is bonded to the PCB by using a heat-resistant glue and is disposed above the sound pickup hole and a hole is punched in the holeless boss.

6. The microphone according to claim 1, wherein the boss is obtained by milling above the sound pickup hole of the PCB by using a numerical control machine tool.

7. The microphone according to claim 1, wherein a material of the boss is a metal, a heat-resistant plastic, or a ceramic.

8. The microphone according to claim 1, wherein a diameter of the boss is less than a diameter of the soldering pad surrounding the sound pickup hole.
